(19) United States
(12) Patent Application Publication
(10) Pub. No.: US 2004/0034759 A1
(43) Pub. Date: Feb. 19, 2004

(54) Multi-threaded pipeline with context issue rules

(75) Inventors: Solomon J. Katzman, Santa Cruz, CA (US); Michael A. Cotsford, Milford, MA (US); Robert G. Gelinas, Needham, MA (US); W. Patrick Hays, Cambridge, MA (US); Todd H. Snyder, Waltham, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Lexra, Inc., Waltham, MA

(21) Appl. No.: 10/274,427

(22) Filed: Oct. 17, 2002

Related U.S. Application Data
(60) Provisional application No. 60/404,346, filed on Aug. 16, 2002.

(51) Int. Cl. G06F 9/00; G06F 15/76; G06F 15/00

(52) U.S. Cl. 712/1

(57) ABSTRACT

An apparatus and method for increasing throughput in a processor having a multi-threaded pipeline is provided. Throughput is increased by dynamically allocating hardware contexts to pipeline flows according to context issue rules. The context issue rules eliminate some hardware bypass paths allowing for a shorter clock period and minimize pipeline stalls. One context issue rule eliminates the need for an E-E bypass path by ensuring that no context is allowed to issue in two adjacent pipeline flows. Another context issue rule eliminates the need for an M-E bypass path by ensuring that data retrieved from memory in a pipeline flow for a context is available prior to a successive pipeline flow for the same context entering the execution stage. A beat issue rule looks for reduced utilization of the pipeline when no active context can issue an instruction due to the context issue rules. By application of the context issue rules, a multi-threaded pipeline can be kept filled and operating at 100% efficiency with as little as two concurrent contexts issuing in alternating cycles.

### RELATED APPLICATION

This application claims the benefit of U.S. Provisional Application No. 60/404,346, filed Aug. 16, 2002. The entire teachings of the above application are incorporated herein by reference.

### BACKGROUND OF THE INVENTION

It has become standard practice in the field of data processor design to exploit the many advantages of instruction pipelining. Indeed, even the most inexpensive microprocessors now typically make use of this technique to at least some extent. Instruction pipelining allows multiple instructions to be processed at the same time in a single processor by dividing instruction processing into a number of different tasks. The tasks needed to implement each instruction are selected and arranged in a defined sequential order. Such instructions may then be processed by a set of circuits arranged to implement each task as a sequentially clocked stage of a hardware pipeline. Instructions are arranged by the processor or a compiler according to an issue policy so that more than one instruction may be processed at the same time, in different stages of the pipeline.

In general, processor throughput is a function of (i) pipeline stage clock speed; (ii) pipeline utilization or “efficiency” during normal execution; and (iii) the number of pipeline stalls occurring during events such as a cache memory miss.

It is known that pipeline utilization can be improved by eliminating, or at least minimizing, procedural dependencies and data dependencies between instructions. For example, a procedural dependency can occur in the context of a conditional branch instruction, where the next instruction cannot be issued until the results of the condition test are known. The performance impact of such dependencies can be reduced through the use of techniques such as speculative issuance of instructions and/or branch prediction. However, each of these adds a layer of complexity to the logic circuits needed to control the progress of specific instructions through the pipeline. These in turn reduce the maximum pipeline clock speed that can be obtained, due to the increased logic delays. A data dependency results in a stall when a later issued instruction requires a result produced by an earlier issued instruction. The later issued instruction cannot therefore proceed until the earlier instruction completes, at least to the point of writing its result back to the register file. The later instruction is thus stalled in the pipeline until the result of the first instruction is available.

FIG. 1 is a high level diagram that illustrates the processing of instructions in a pipelined processor. This particular pipelined processor executes instructions concurrently with one instruction started and one instruction completed every clock cycle. Thus, the number of instructions that can be concurrently processed, with each instruction processed in a different stage in the pipeline depends upon the number of stages in the pipeline. Each issued instruction flows through all stages of the pipeline and is also referred to herein as a pipeline “flow”.

This particular pipeline also supports multi-threading, which is the ability to process more than one program thread or “context” at a time. A context is defined as the contents of a register file, other state information and the contents of a program counter for a particular program thread.

A thread is a program segment and its associated context state information. Multi-threading is an architectural technique that allows task switching between threads. There are two forms of multi-threading: coarse grained and fine grained. In coarse-grained multi-threading, a single thread consumes all of the CPU cycles until a context switch occurs. In fine grained multi-threading, execution rotates cycle-by-cycle among different threads.

Multi-threading is typically implemented by an instruction scheduler that selects instructions to be issued to the pipeline from one or more contexts. In fine-grained multi-threading, the scheduler may select instructions from the contexts on a cycle-by-cycle basis according to a round robin, priority scheme, or some other selection mechanism. What should be understood here is that in a multi-threaded pipeline of either type, an instruction associated with pipeline “Flow N+1” may or may not originate from a context which is different from the context associated with the immediately preceding “Flow N”.

The illustrated processor is a Reduced Instruction Set Computer (RISC) type processor which has seven stages in the pipeline, including an: I-stage (I-cache access); D-stage (Decode, instruction cache verification, set selection and instruction transfer); S-stage (Source: register file read access); E-stage (Execution); A-stage (data cache access); M-stage (data cache verification, set selection, read data transfer); and W-stage (Write back result to the register file).

In such a pipeline, multiple instructions are typically processed concurrently with each instruction occupying a different stage of the pipeline in any given cycle. During the I-stage, an instruction is fetched from instruction cache at the address stored in the program counter associated with the issuing context. During the D-stage, the instruction fetched in the I-stage is decoded and the address of the next instruction to be fetched for the issuing context is computed. During the S-stage, instruction operands stored in the register file are fetched and forwarded to the E-stage, if required by the instruction. During the E-stage, the Arithmetic Logic Unit (ALU) performs an operation dependent on the type of instruction. For example, the ALU begins the arithmetic or logical operation for a register-to-register instruction, calculates the virtual address for a load or store operation or determines whether the branch condition is true for a branch instruction. During the A-stage a D-Cache access is performed for a load or a store operation. During the M-stage, read data is aligned and transferred to its destination. During the W-stage, the result of a register-to-register or load instruction is written back to the register file.

Consider even a simple instruction such as an ADD instruction. The result of an operation in the E-stage cannot be written back to the register file until the W-stage. Thus, any later issued instruction in the pipeline which operates on the result of the ADD instruction must stall until the result of the ADD instruction is written to the register file. The later instruction is stalled by delaying the instruction that waits for the result.

Bypass paths are typically provided from stages of the pipeline after the execution stage. Bypass paths allow results to be forwarded back to the execution stage for use in later issued instructions. Such bypass paths thus reduce the frequency of pipeline stalls. As one example, a bypass path from the M-stage to the E-stage 104 forwards the result to the E-stage for use by a later issued instruction, but before the result must be written to the register file in the W-stage.

Consider a more specific example, in particular, the sequence of instructions for one context illustrated in Table 1 below:

TABLE 1

| | |
|---|---|
| Flow N | Instruction 1 add r3, r2, r1 |
| Flow N + 1 | Instruction 2 add r5, r4, r3 |
| Flow N + 2 | Instruction 3 add r6, r3, r4 |
| Flow N + 3 | Instruction 4 add r2, r3, r1 |
| Flow N + 4 | Instruction 5 add r7, r3, r8 |

As will be understood shortly, the addition of four bypass paths to the pipeline will allow this particular sequence of instructions for one context to be processed without stalling the pipeline. These bypass paths allow the result to be forwarded from the E-stage to the E-stage, the A-stage to the E-stage, the M-stage to the E-stage and the W-stage to the E-stage.

Consider how the sequence of instructions in Table 1 would be processed by the pipeline of FIG. 1. Instruction 1 is issued in pipeline Flow N. Instruction 1 adds the contents of r1 to r2 and stores the result in r3. The result is stored in r3 in the W-stage of the pipeline.

Instruction 2 is issued in the second pipeline flow, i.e., pipeline Flow N+1. Instruction 2 adds r3 to r4 and stores the result in r5. Thus, instruction 2 requires the result of instruction 1 in the E-stage. An E-E bypass path 100 thus allows the result of instruction 1 in the E-stage of pipeline Flow N to be forwarded to the E-stage for use by instruction 2 in pipeline Flow N+1.

Instruction 3 is issued in pipeline Flow N+2. Instruction 3 also uses the result of instruction 1 in the E-stage. An A-E bypass path 102 allows the result of instruction 1 in the A-stage of pipeline Flow N to be forwarded to the E-stage for use by instruction 3 in pipeline Flow N+2.

Instruction 4 is issued in pipeline Flow N+3. Instruction 4 also uses the result of instruction 1 in the E-stage. An M-E bypass path 104 allows the result of instruction 1 in the M-stage of pipeline Flow N to be forwarded to the E-stage for use by instruction 4 in pipeline Flow N+3.

Instruction 5 is issued in pipeline Flow N+4. Instruction 5 also uses the result of instruction 1 in the E-stage. A W-E bypass path 106 allows the result of instruction 1 in the W-stage of pipeline Flow N to be forwarded to the E-stage for use by instruction 5 in Flow N+4.

FIG. 2 is a more detailed hardware block diagram of an instruction pipeline 220, showing the necessary hardware bypass paths for forwarding the results of previously issued instructions through a multiplexor 222 to the E-stage 200 for use by a later issued instruction. The pipeline 220 includes an E-stage 200, an A-stage 202, an M-stage 204 and a W-stage 206. The hardware bypass paths include an E-E bypass 208, an A-E bypass 210, an M-E bypass 212 and a W-E bypass 214. The multiplexor 222 has a high fan-in to handle the large number of cases for which the register file must be bypassed. This multiplexor 222 adds logic gate propagation delays- and this in turn extends the cycle time needed to execute each instruction. Because each stage of the pipeline must be clocked in synchronism, the pipeline speed must be set to accommodate the pipeline stage that has the longest propagation delay. Thus, the addition of hardware bypass paths may cause the pipeline 220 to be operated at a lower clock speed.

Of course, any of the bypasses can be eliminated if instructions are instead simply suspended while waiting for results to be written to the register file. However, suspending pipeline flows wastes pipeline cycles and thus also reduces throughput.

### SUMMARY OF THE INVENTION

Briefly, the present invention is directed to a multi-threaded instruction pipeline in which throughput is increased by issuing instructions based upon so-called “context issue” rules.

More specifically, the multi-threaded pipeline is one in which a plurality of threads, or more generally, instruction “contexts”, may be concurrently processed. A context scheduler dynamically assigns the plurality of contexts to pipeline flows according to one or more context issue rules.

In one embodiment, the number of contexts concurrently processed is at least two but may be higher. In this preferred embodiment, a context issue rule prevents a context which issues in pipeline Flow N from issuing in the very next pipeline Flow N+1. Thus, by ensuring that no context is allowed to issue in two adjacent pipeline flows, the result of an execution stage in a pipeline flow for a specific context is available at least one cycle before the execution stage in any successive pipeline flow for that same context.

Another context issue rule may also control issuance of pipeline flows occurring later than Flow N+1. For example, in a case where the multi-threaded pipeline has multiple bypass paths, this context issue rule eliminates the need for an M-E bypass path. The M-E bypass path is eliminated by preventing a context which issues in pipeline Flow N from issuing in pipeline Flow N+P which may require the result of the M-stage in pipeline Flow N to be forwarded to the E-stage of the later pipeline flow. P is dependent on the configuration of at least two predetermined pipeline stages. The predetermined stages may be an execution stage and a memory stage.

Still further refinements of the context issue rules are possible. A beat issue rule prevents reduced utilization of the pipeline when no active context can issue an instruction due to the context issue rules. For example, if the context issue rules prevent the same context from issuing in Flows N+1 and N+3, upon determining that no context issued in pipeline Flows N+3 and N+1, and that a different context issued in Flow N+2, a context which issued in pipeline Flow N can advantageously be prevented from also issuing in pipeline Flow N+4.

The invention provides several advantages over the prior art. For example, by issuing instructions based on one or more context issue rules, the need for at least some of the bypass paths in the instruction pipeline is eliminated. This in turn allows a higher pipeline clock rate.

Pipeline stalls resulting from delayed results of complex operations, such as multiplier-accumulator results, are also less frequent. Pipeline stalls on conditional branch instructions can also be avoided without the need for branch prediction. This is because a result of a branch condition test will now be available for the next instruction in the same context, without resorting to branch prediction logic. The result of the condition test may be available after a delay slot instruction dependent on the number of pipeline stages between the I-stage and the E-stage. A jump destination resulting from a data dependent jump instruction is immediately available, without stalling the pipeline. Pipeline stalls due to the result of a load instruction being used in the next issued instruction for the same context are also less frequent.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high level diagram that illustrates the processing of instructions in a pipelined processor;

FIG. 2 is a more detailed hardware block diagram of an instruction pipeline showing the necessary hardware bypass paths for forwarding the results of previously issued instructions to the E-stage for use by a later issued instruction;

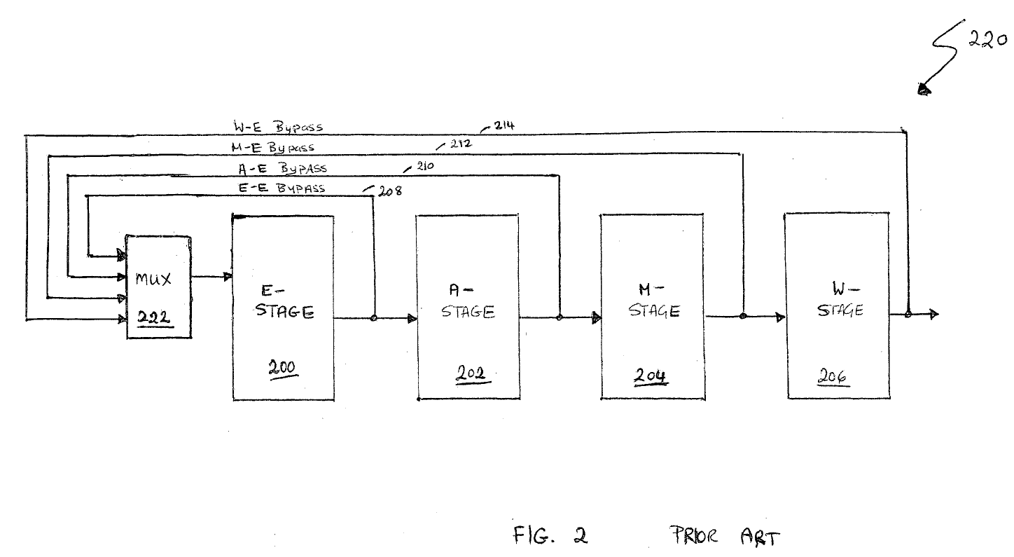

FIG. 3A is a block diagram of a fine-grained multi-threaded Reduced Instruction Set Computer (RISC) processor in which throughput is increased by issuing instructions to a pipeline according to the principles of the present invention;

FIG. 3B is a more detailed block diagram of the scheduler;

FIG. 4A is a flow diagram of how instructions may be issued for one context according to the E-E bypass elimination context issue rule in a seven stage pipeline;

FIG. 4B is a flow diagram of how instructions may be issued to avoid stalls in a seven stage pipeline for an instruction using the result of a load instruction;

FIG. 4C is a flow diagram of how instructions may be issued for one context according to the E-E bypass elimination context issue rule and an M-E bypass elimination context issue rule for a pipeline with one stage between the E-stage and the M-stage.

FIG. 4D is a flow diagram of how instructions may be issued for one context according to the E-E bypass elimination context issue rule and the M-E bypass elimination context issue rule for a pipeline with no stages between the E-stage and the M-stage.

FIG. 4E is a flow diagram of how instructions may be issued for one context according to the E-E bypass elimination context issue rule and the M-E bypass elimination context issue rule for a pipeline with two stages between the E-stage and the M-stage.

FIG. 5 is a block diagram of a portion of the instruction pipeline in the processor;

FIG. 6 is a flow diagram of instructions issued for one context according to the E-E bypass elimination context issue rule in a six-stage pipeline with one stage between the I-stage and the E-stage.

FIG. 7 is a flow diagram of instructions issued for one context according to the E-E bypass elimination context issue rule in a five-stage pipeline in which the E-stage is adjacent to the I-stage;

FIG. 8 illustrates instruction scheduling based on context issue rules in the processor shown in FIG. 3A with four active threads;

FIG. 9 is a flow diagram illustrating 50% utilization of the pipeline with two contexts issuing instructions according to context issue rules; and

FIG. 10 illustrates pipeline utilization for the sequence of instructions shown in FIG. 9 with instructions issued according to context issue rules and a beat issue rule.

### DETAILED DESCRIPTION OF THE INVENTION

A description of preferred embodiments of the invention follows.

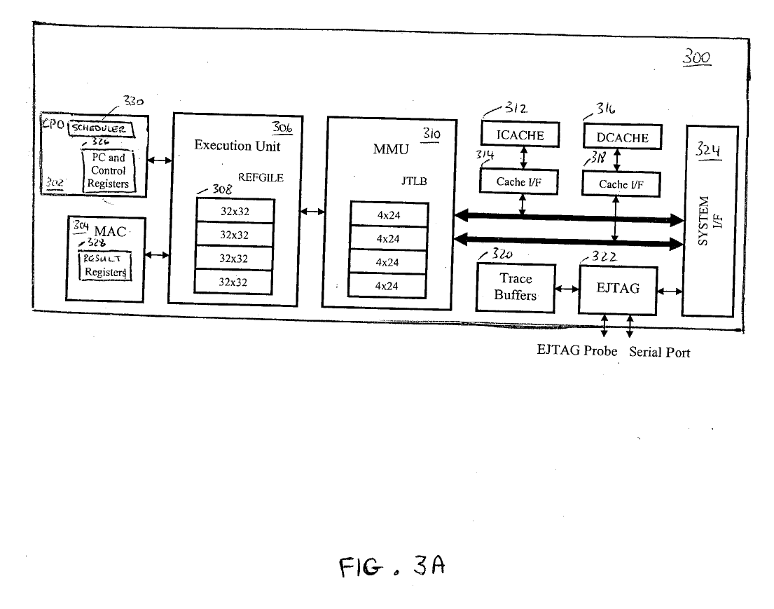

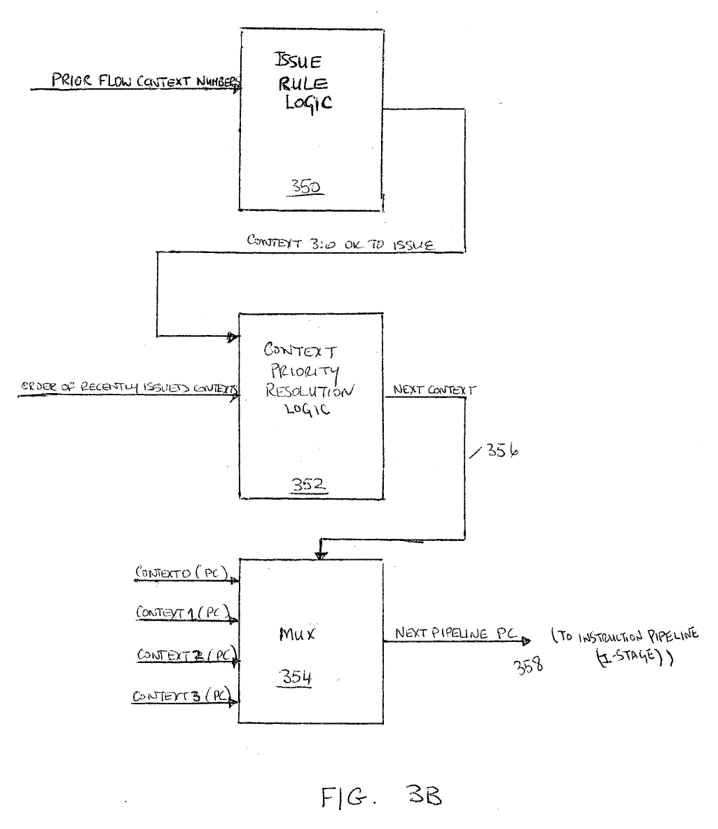

FIG. 3A is a block diagram of a fine-grained multi-threaded Reduced Instruction Set Computer (RISC) processor in which throughput is increased by issuing instructions to an instruction pipeline according to the principles of the present invention. The RISC processor includes an Execution Unit 306, a Memory Management Unit (MMU) 310, a Co-Processor (CP0) 302, an Instruction Cache (ICache) 312, a Data Cache (DCache) 316 and a Multiply-Accumulate Controller (MAC) 304. The RISC processor 300 also includes trace buffers 320 and an EJTAG interface 322 allowing debug operations to be performed. A system interface 324 provides access to external memory (not shown).

The Execution Unit 306 includes a plurality of identical 32×32 bit general purpose register files which are used to implement hardware based multi-threading. The CP0 302 includes a scheduler 330 for issuing instructions—according to the present invention, the scheduler 330 will make use of one or more context issue rules and beat issue rules.

Multi-threading allows multiple threads or contexts to share the instruction pipeline. To support multi-threading, each thread has its own register file and program counter (PC) and other state information. The context data is the data that is accessed from the register file when the corresponding thread is executing. Upon suspending a thread, due to a cache miss, for example, the context data and the contents of the program counter are preserved. The context data and the program counter (PC) contents are thus still valid when a thread is resumed after the condition that resulted in the suspension of the thread is resolved.

A context can thus be defined as the contents of the register file, other state information and the contents of the PC for a particular thread.

A so-called fine-grained multi-threaded processor rotates instruction execution cycle-by-cycle among the different active contexts. Operation of the contexts is thus interleaved, with the interleaving typically performed in a round-robin fashion. For example, with four active contexts, (T0-T3) the contexts may issue in alternate pipeline flows as follows T0 (Flow N); T1 (Flow N+1); T2 (Flow N+2); and T3 (Flow N+3). The round-robin scheduling typically takes into account any stalled contexts, and will skip them when issuing instructions as long as they remain stalled. For example, in the case of a cache miss in context X, X gives up its pipeline flows to other contexts that can take them until the cache miss is resolved.

The invention is described herein for a processor allowing four active contexts, i.e., with four sets of the registers needed to support context execution. Thus, there are four register files 308 in the Execution Unit 306, four sets of result registers 328 in the MAC 304, four PCs and four sets of Control registers 326 in the CP0 302. However, the invention is not limited to implementation in pipelines that support four contexts—the invention can be implemented in any multi-threaded processor as long as there are at least two sets of register files for storing two contexts.

FIG. 3B is a more detailed block diagram of the scheduler 330. The scheduler 330 selects the program counter contents to forward to the I-stage of the instruction pipeline. Each context has an associated program counter (PC) which stores a pointer to the next instruction to be issued for the context. One of the available contexts is selected dependent on one or more context issue rules and beat issue rules.

Issue rule logic 350 determines which of the contexts can issue in Flow N dependent on the contexts which issued in the prior flows. The issue rule logic 350 prevents a context which issued in a particular flow from issuing in a successive flow. For example, a context issuing in Flow N−1 is prevented from issuing in Flow N. The available contexts are forwarded to the context priority resolution logic 352. The context priority resolution logic 352 selects one of the available contexts.

The context priority resolution logic 352 selects the context which issued earlier than the other available contexts which can be issued. The next context 356 to be issued is coupled to the multiplexor 354. The next context 356 selects the program counter for the selected context. The contents of the selected program counter 358 are issued to the I-stage of the instruction pipeline to fetch the next instruction for the selected context.

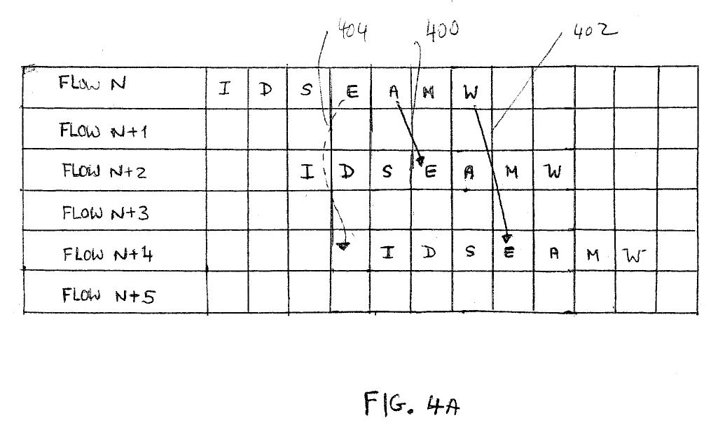

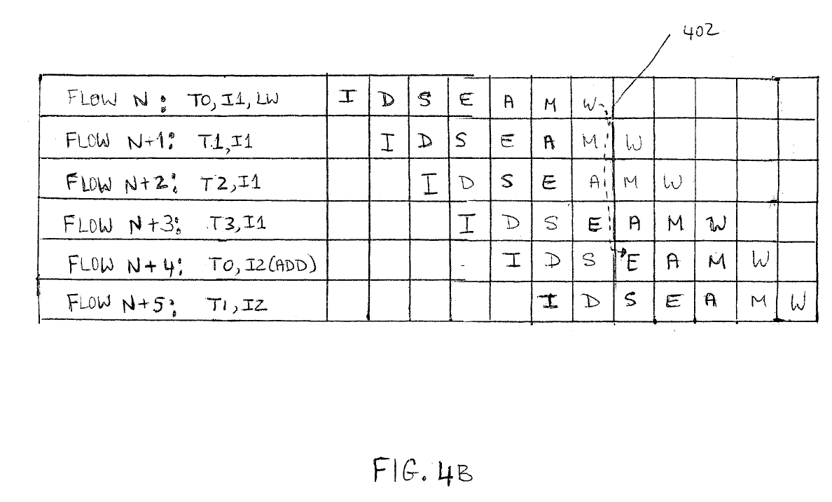

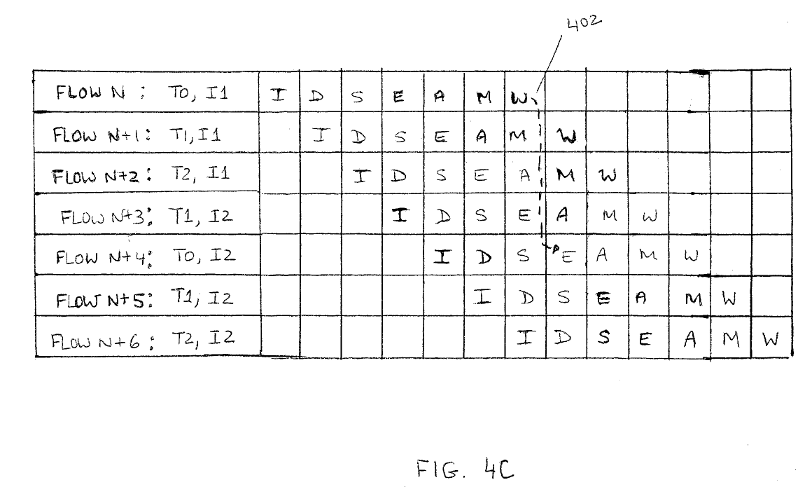

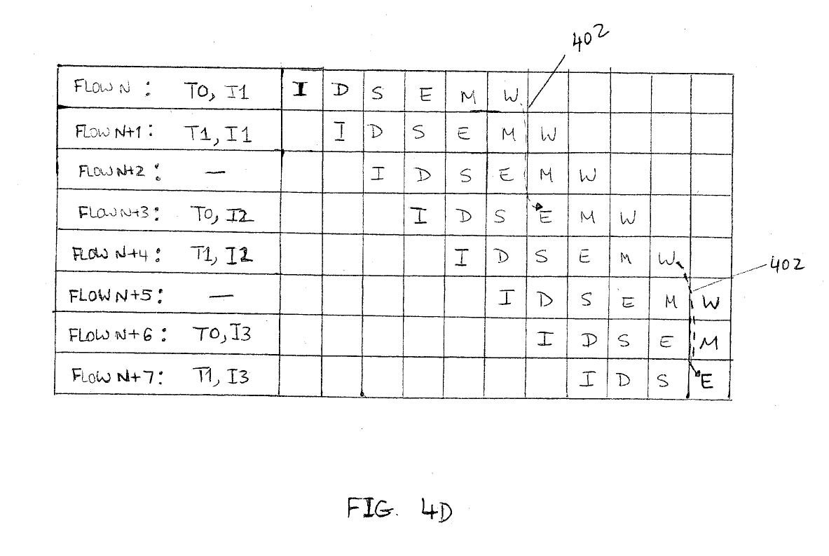

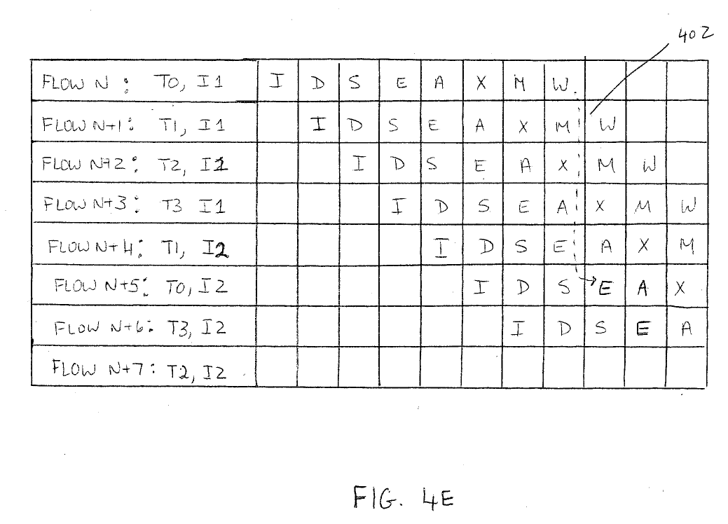

FIG. 4A is a flow diagram of how instructions may be issued for one context according to an E-E bypass elimination context issue rule. The E-E-bypass path is a speed-critical bypass path. During the E-stage, the Arithmetic Logic Unit (ALU) performs an operation dependent on the type of instruction. For example, the ALU begins the arithmetic or logical operation for a register-to-register instruction, calculates the virtual address for a load or store operation or determines whether the branch condition is true for a branch instruction. The E-E bypass path bypasses the results from the execution unit through several levels of multiplexors to the ALU input registers. Thus, the elimination of the speed-critical E-E bypass path allows the processor to be operated at a higher clock period.

The instruction pipeline shown is implemented in the processor 300, and has seven stages. The scheduler 330 issues instructions to the pipeline on a cycle-by-cycle basis based on the E-E bypass elimination context issue rule. More particularly, the E-E bypass elimination context issue rule issues instructions such that if an instruction for a context is issued in pipeline Flow N, an instruction cannot be issued for the same context in Flow N+1. Rather, the next instruction for the same context cannot issue until at least Flow N+2. Thus, instructions for the same context are prevented from issuing in back to back cycles, by the expedient of not allowing an instruction which issues in pipeline Flow N to issue in the next successive pipeline Flow N+1.

The flow diagram of FIG. 4A only shows instructions issued for one context. Instructions for other contexts (not shown) may be issued in the other pipeline flows.

The first instruction for the context is issued in pipeline Flow N, and begins to be processed in the instruction pipeline. Instructions are concurrently executed with each instruction being executed by a different stage, with the maximum number of concurrently executing instruction being dependent on the number of stages in the pipeline. According to the E-E bypass elimination context issue rule the second instruction for the context is then issued in pipeline Flow N+2.

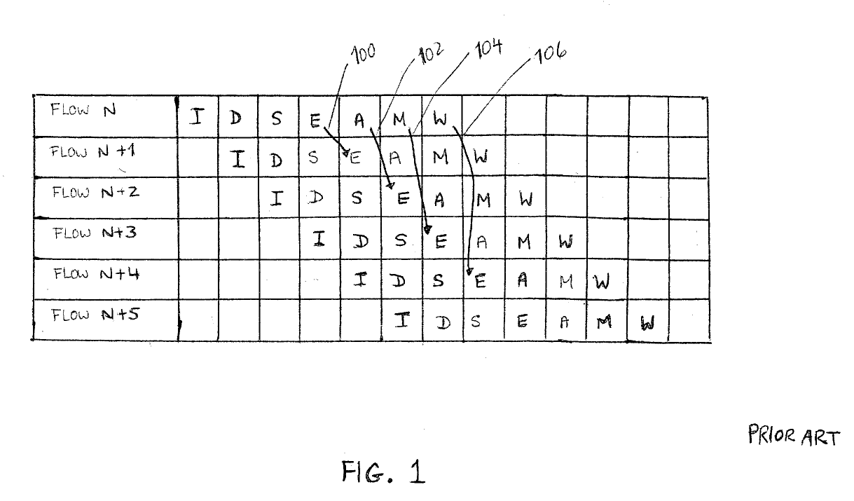

When the second instruction is in the I-stage in pipeline Flow N+2, the first instruction is in the D-stage. Referring back to the particular seven stage pipeline structure of FIG. 1, when pipeline Flow N+2 is in the S-stage of the instruction pipeline, the result of the instruction issued in pipeline Flow N has already reached the A-stage. Thus, there is no need for an E-E bypass, since the pipeline Flow N instruction result will already be available in the A-stage by the time that Flow N+2 needs the result in the E-stage. Thus, the result of the instruction issued in Flow N in the A-stage is forwarded to the E-stage for use by the instruction in Flow N+2 through A-E bypass path 400. So, by observing a context issue rule such that an instruction for the same context is never issued in pipeline Flow N+1, at least one set of bypass logic can be eliminated (i.e., the E-E bypass).

The third instruction for the context is issued in pipeline Flow N+4. When Flow N+4 is in the S-stage, the result of the instruction that issued in pipeline Flow N has reached the W-stage. The result of the instruction issued in Flow N which is in the W-stage is forwarded to the E-stage through W-E bypass path 402 for use by pipeline Flow N+4.

In this particular case, an M-E bypass is not required because the same context issued in Flow N and Flow N+2 and was thus prevented from issuing in N+3 due to the E-E bypass elimination context issue rule. However, if a different context or no context issues in Flow N+2, the N+1 rule does not prevent the context issuing in Flow N from issuing in Flow N+3 which may require an M-E bypass. Thus, another context issue rule is required to eliminate the M-E bypass. The M-E bypass elimination context issue rule is described later in conjunction with FIG. 4C.

The E-E bypass elimination context issue rule also eliminates the need for branch prediction in many, if not all, types of pipeline. This can be illustrated using the sequence of conditional branch instructions shown in Table 2 below:

TABLE 2

beq, r1, r2, offset
<delay slot, always executed>
next instruction after beq or branch to target instruction

It should be noted here that most RISC processors use a delayed branch scheme which results in the first instruction after a branch always being executed, even if the branch is taken.

Referring to FIG. 4A, the conditional branch instruction (beq) would for example, be issued in pipeline Flow N. The instruction to be issued two instructions after the branch instruction is dependent on the result of a test which is performed at the beginning of the E-stage cycle in pipeline Flow N. The instruction after the branch conditional is always executed. It is inserted by the compiler and is called a “delay slot” instruction. The delay slot instruction is a valid instruction. According to the E-E bypass elimination context issue rule, however, the delay slot instruction is not issued until pipeline Flow N+2. The result of the register compare for the conditional branch is available in the E-stage of pipeline Flow N. So, by the time that the next instruction for the context is fetched in the I-stage of Flow N+4, the result 404 is available in the E-stage of pipeline Flow N prior to the I-stage of pipeline Flow N+4. The instruction can thus be fetched in the I-stage of pipeline Flow N+4 using the result 404 of the conditional branch instruction executed in the E-stage of pipeline Flow N. Therefore, by the time the decision must be made as to whether to issue the instruction two instructions after the conditional branch instruction (i.e., the instruction after the “delay slot” instruction) or the instruction in the code segment selected by conditional branch instruction, the result of the branch instruction is already available. Thus, no branch prediction is required to pre-fetch instructions, speculate as to condition results, etc., while still maintaining maximum pipeline efficiency.

FIG. 4B is a flow diagram of how instructions may be issued to avoid stalls in the pipeline for an instruction using the result of a load instruction. The result of a load instruction is not available until the data read from memory has been written to the register file. In a single threaded pipeline, a subsequent instruction that requires the result of the load must be stalled until the data is available. Typically, a pipeline interlock detects the condition and stalls the pipeline until the data is available. The pipeline interlock stalls the pipeline beginning with the instruction that needs the data until the earlier issued instruction provides the data.

A stall is not required if there are four active contexts issuing instructions to the pipeline. This can be illustrated using the sequence of instructions shown in Table 3 below.

TABLE 3

LW r3, offset (base)
ADD rd, rs, r3

The LW instruction loads data stored in memory at offset (base) to the r3 register. The ADD instruction then uses the data read from memory after it has been loaded into r3.

These instructions are processed as follows. Context 0 issues the load instruction in pipeline Flow N. Next, Context 1 issues an instruction in pipeline Flow N+1, Context 2 issues an instruction in pipeline Flow N+2 and then Context 3 issues an instruction in pipeline Flow N+3.

Context 0 issues an ADD instruction in pipeline Flow N+4. The ADD instruction issued in pipeline Flow N+4 needs the result of the LW instruction issued in pipeline Flow N by the E-stage of pipeline Flow N+4. When pipeline Flow N+4 reaches the S-stage, the result of pipeline Flow N has already reached the W-stage. Thus, no stall cycles are required.

Stalls may still be required dependent on the number of active contexts. However, even with two active contexts issuing in alternate cycles, the number of stall cycles is reduced due to the E-E bypass elimination context issue rule.

Another example of the improvement afforded by the E-E bypass elimination context issue rule is observed with the application of co-processors such as multiply-accumulators (MACs) or other co-processors which may require more than one processor cycle to return a result to the pipeline. In this example, the MAC 304 (FIG. 3A) has a single multiplier for performing multiply operations and a single divider for performing divide operations. In this particular architecture, the divider and the multiplier are shared by all contexts, although each context has a separate set of result registers for storing the result of MAC operations. In one preferred embodiment of the invention, a divide operation can take up to eighteen cycles to complete. Due to the E-E bypass elimination context issue rule, a given context executes fewer instructions in a given time period because a context can only issue in alternate pipeline flows. In the worst case scenario, with an instruction issuing for the context in every other pipeline flow, only nine instructions can be issued for the context during the eighteen cycles used by the divider to perform the divide operation. Thus, stalls resulting from delayed results of the divide operation actually have less impact on expected execution throughput due to the E-E bypass elimination context issue rule.

FIG. 4C is a flow diagram of how instructions may be issued for one context according to the E-E bypass elimination context issue rule and an M-E bypass elimination context issue rule for a pipeline with one stage between the E-stage and the M-stage. The M-E bypass path is also a speed critical bypass path. During the M-stage, read data is aligned and transferred to its destination. The M-E bypass bypasses load data after data cache tag match, alignment shifting, bus transfer and multiplexing to the input registers of the ALU.

The M-E bypass elimination context issue rule is dependent on the number of stages between the E-stage and the M-stage in the pipeline. In the embodiment shown, there is one stage (the A-stage) between the E-stage and the M-stage.

The first instruction for T0 is issued in pipeline Flow N. The first instruction for T1 is issued in pipeline Flow N+1. The first instruction for T2 is issued in pipeline Flow N+2. According to the E-E bypass elimination context issue rule, the second instruction for T0 can be issued in Flow N+3. However, an M-E bypass is required if the instruction issued for T0 issued in Flow N+3 requires the result of the first instruction for T0 which issued in Flow N.

Thus, an additional context issue rule is implemented in order to eliminate the need for the M-E bypass. In a pipeline with one stage between the E-stage and the M-stage, the M-E bypass elimination context issue rule prevents a context which issues in Flow N from issuing again in Flow N+3. According to this context issue rule the second instruction for T1 is issued in pipeline Flow N+3 instead of the second instruction for T0. When Flow N+4 is in the S-stage, the result of the first instruction for T0 which issued in Flow N is in the W-stage and thus can be provided to the E-stage for use by the second instruction for T0 in Flow N+4 through the W-E bypass 402.

FIG. 4D is a flow diagram of how instructions may be issued for one context according to the M-E bypass elimination context issue rule for a pipeline with no stages between the E-stage and the M-stage.

The M-E bypass is required if an instruction issued for a context in pipeline Flow N+2 requires the result of an instruction issued for the context in Flow N. The need for an M-E bypass is eliminated by preventing a context which issues in Flow N from issuing again in Flow N+2.

As shown in FIG. 4D, there are two active contexts T0 and T1. A first instruction for T0 is issued in Flow N. A first instruction for T1 is issued in Flow N+1. An instruction cannot be issued for T0 or T1 in Flow N+2. An instruction cannot be issued for T0 due to the M-E bypass elimination context issue rule. An instruction cannot be issued for T1 due to the E-E bypass elimination context issue rule. Thus, with only two active contexts, no instruction can be issued in Flow N+2. A second instruction is issued for T0 in Flow N+3. By the time Flow N+3 requires the result of the instruction issued in Flow N, the result is in the W stage and is bypassed to the E-stage for use by Flow N+3 through W-E bypass 402.

Thus, the M-E bypass elimination context issue rule is dependent on the number of stages between the M-stage and the E-stage. The rule prevents a context which issues in Flow N from issuing in Flow (N+2+X), where X is the number of stages between the E-stage and the M-stage. In a pipeline with no stages between the E-stage and the M-stage, the context issue rule prevents a context which issues in Flow N from issuing again in Flow N+2. In a pipeline with one stage between the E-stage and the M-stage as shown in FIG. 4C, the context issue rule prevents a context which issues in Flow N from issuing in Flow N+3.

FIG. 4E is a flow diagram of how instructions may be issued for one context according to the E-E bypass elimination context issue rule and an M-E bypass elimination context issue rule for a pipeline with two stages between the E-stage and the M-stage.

As already discussed in conjunction with FIGS. 4C and 4D, the M-E bypass elimination context issue rule is dependent on the number of stages between the E-stage and the M-stage. Thus, in a pipeline with three stages between the E-stage and the M-stage as shown in FIG. 4E, the context issue rule prevents a context which issues in Flow N from issuing in Flow N+4. By the time an instruction issued for T0 in Flow N+5 is in the S-stage, the result of the instruction which issued in Flow N for T0 is available for use by Flow N+5 through the W-E bypass 402.

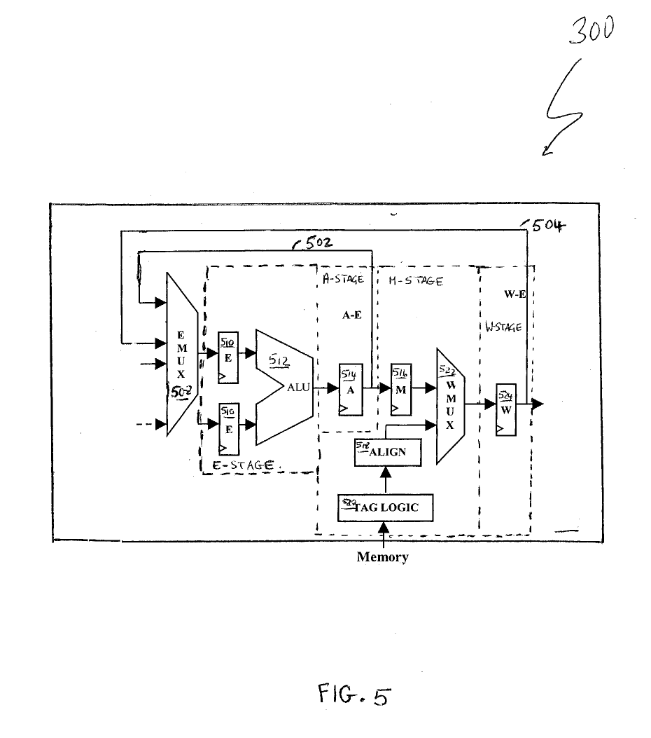

FIG. 5 is a block diagram of a portion of the instruction pipeline in the processor 300. The single instruction pipeline is shared by all active contexts. The illustrated seven stage pipeline includes an I-stage, D-stage, S-stage, E-stage, A-stage, M-stage and W-stage, although only the E-stage, A-stage, M-stage and W-stage are shown in FIG. 5. Each instruction is passed through each stage of the pipeline so that each instruction takes the same number of clock cycles.

The E-stage includes two registers 510 and an Arithmetic Logic Unit (ALU) 512.

The A-stage includes a register 514 for storing the results of the E-stage.

The M-stage includes a register 516 for receiving the result from the A-stage, alignment logic 518, tag logic 520 and a multiplexor 522 for forwarding data received from memory and the A-stage to the W-stage.

The W-stage includes a register 524 for storing the result to be stored in the register file.

There is an A-E bypass 502 for forwarding results from the A-stage to the E-stage. There is also a W-E bypass 504 for forwarding the results from the W-stage to the E-stage. Note that the E-E and M-E bypass have been eliminated because the E-E bypass elimination context issue rule prevents a context which issues an instruction in pipeline Flow N from issuing in pipeline Flow N+1 and the M-E bypass elimination context issue rule prevents a context which issues an instruction in pipeline Flow N from issuing in pipeline Flow N+3. Thus the E-E and M-E bypasses are never required.

The fan-in required for the multiplexor 508 is reduced due to the elimination of the E-E and M-E bypass paths which reduces the propagation delay to the E-stage. ALU combinational results can be simply registered because they are not forwarded to the E-stage until after the A-stage. Also, various ALU functions can have their own result registers. Similarly, the results of tag match and data selection and alignment can be simply registered because they are not forwarded to the E-stage until after the W-stage. The elimination of the E-E and M-E bypass paths allows the processor to be operated at a higher clock period. Also, the context issue rules reduce silicon area by eliminating the necessity for bypass paths. This reduces the complexity of the logic resulting in less logic to be tested.

The invention has been described herein for a 7-stage instruction pipeline, but it should be understood that the invention is not so limited.

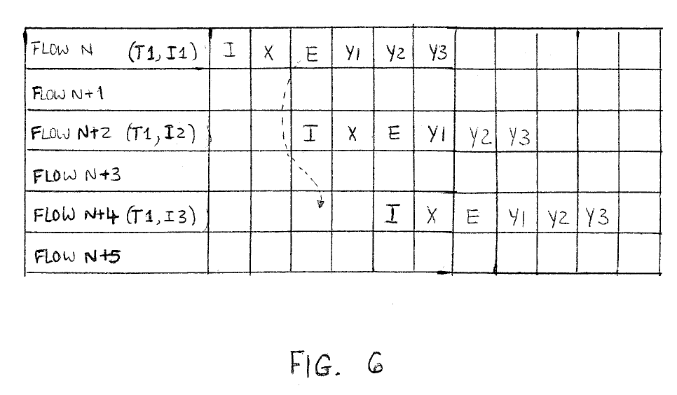

The elimination of branch prediction as a result of the E-E bypass elimination context issue rule has been described for a 7-stage instruction pipeline in which there are two stages (D and S) between the I-stage and the E-stage and a delay slot instruction is always inserted after the branch. However, the E-E bypass elimination context issue rule can also result in the elimination of branch prediction in an instruction pipeline with one stage between the I-stage and the E-stage and in which a delay slot instruction is inserted after the branch instruction. Such a sequence of instructions issued to the instruction pipeline is shown in FIG. 6.

FIG. 6 is a flow diagram of instructions issued for one context according to the E-E bypass elimination context issue rule in a six-stage pipeline with one stage between the I-stage and the E-stage.

In one embodiment of a six-stage pipeline the Y1 stage corresponds to the A-stage, the Y2 stage corresponds to the M-stage and the Y3 stage corresponds to the W-stage as described for the 7-stage pipeline.

If a branch instruction for T1 is issued in Flow N, and the delay slot instruction for T1 is issued in Flow N+2, then the result is available prior to the I-stage of the next instruction for T1 in Flow N+4. If the architecture does not specify a delay slot instruction after a branch instruction, branch prediction is not eliminated but the number of stall cycles is reduced because the result of the E-stage is not available before the I-stage of the instruction for T1 issued in Flow N+2.

The elimination of branch prediction as a result of the E-E bypass elimination context rule in a six-stage pipeline also applies to a five-stage pipeline and a four-stage pipeline. In one embodiment of five-stage pipeline Y1 stage corresponds to the M-stage, the Y2 stage corresponds to the W-stage and there is no Y3 stage. In one embodiment of a four-stage pipeline, the Y1 stage corresponds to the W-stage and there are no Y2 and Y3 stages.

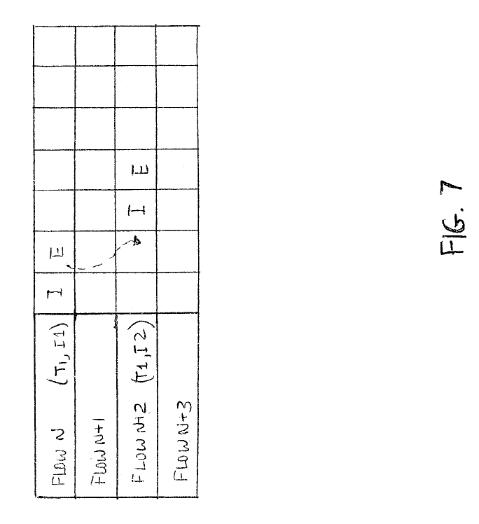

The E-E bypass elimination context issue rule also results in the elimination of branch prediction in an instruction pipeline with no stages between the I-stage and the E-stage in which a delay slot instruction is not inserted after the branch instruction as is shown in FIG. 7.

The elimination of branch prediction as a result of the E-E bypass elimination context issue rule also applies to pipelines with more than three stages after the E-stage. The result of the branch prediction is provided by the E-stage to the I-stage for use by a later issued instruction and is thus independent of the number of stages after the E-stage.

FIG. 7 is a flow diagram of instructions issued for one context according to the E-E bypass elimination context issue rule in a five-stage pipeline in which the E-stage is adjacent to the I-stage;

Here, the delay slot instruction is not needed with the E-E bypass elimination context issue rule because the result is available before the I-stage of Flow N+2.

In general, the invention can be used to increase throughput in any instruction pipeline by eliminating the necessity for E-E and M-E hardware bypass paths to forward results to the E-stage of the pipeline for use by a later issued instruction. The E-E bypass elimination context issue rule eliminates the need for an E-E hardware bypass path by preventing a context which issues in pipeline Flow from issuing in a subsequent pipeline Flow. The E-E bypass elimination context issue rule is independent of the number of pipeline stages between the I-stage and the E-stage. The M-E bypass elimination context issue rule eliminates the need for an M-E hardware bypass path by preventing a context which issues in pipeline Flow N from issuing in pipeline Flow N+P where P is dependent on the number of pipeline stages between the E-stage and the M-stage.

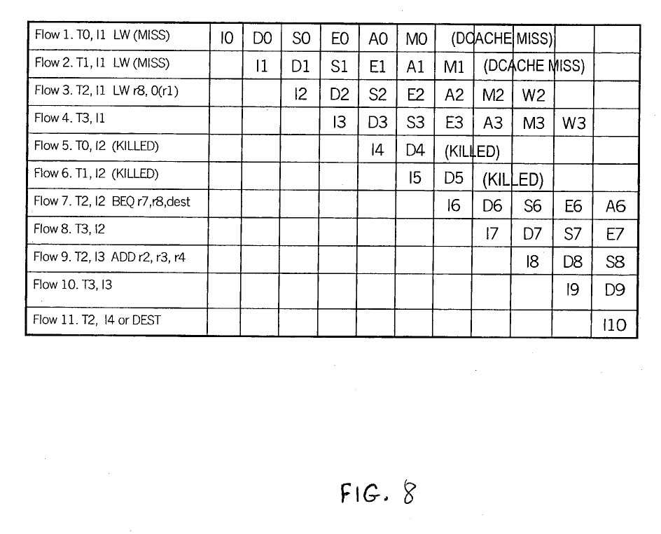

FIG. 8 illustrates instruction scheduling based on context issue rules for the seven-stage pipeline shown in FIG. 3A, with four active contexts (T0, T1, T2, T3).

In general, instructions are issued from each active context in round robin fashion. Pipeline flows are reallocated after a cache miss which is detected in the M-stage, so that any such context which is suspended is removed from the round-robin list until the cache miss is resolved. Thus, when a context is suspended, the other three contexts can make use of the extra available flows that would otherwise be allocated to the suspended context, but allocation of the extra flows is based on the context issue rules.

In this example, the first instruction (Load Word (LW)) is issued for T0 in pipeline Flow 1. The LW instruction requires a read from memory. A cache miss is detected in the M-stage (M0) of pipeline Flow 1 because the data is not yet stored in the cache.

The first instruction (LW) is issued for T1 in pipeline Flow 2. The LW instruction requires a read from memory which is performed in the M-stage. The cache miss is detected in the M-stage and this context is also suspended because the data is not yet stored in the cache.

The first instruction for T2 is issued in pipeline Flow 3. This instruction is a load word instruction which loads the contents of memory addressed by the contents of register 1 (r1) into register 8 (r8). It can proceed since the memory contents are available in cache.

The first instruction for T3 is issued in pipeline Flow 4.

The second instruction for T0 is next issued in pipeline Flow 5. The second instruction for T1 is issued in pipeline Flow 6. Pipeline Flows 5 and 6 are killed when the cache miss condition (resulting from misses for instructions issued in pipeline Flows 1 and 2) are detected in the M-stage (M0 and M1). Pipeline Flows 5 and 6 need be killed only if the issued instructions are dependent on the result of the respective instructions issued in pipeline Flows 1 and 2. Otherwise, pipeline Flows 5 and 6 can proceed through the pipeline. After the cache misses are resolved, the pipeline flows are restarted for T0 and T1 using their respective saved hardware contexts.

However, while T0 and T1 are suspended, pipeline flows can still be completely allocated to T2 and T3 according to the context issue rules. For example, instructions from T2 can still be issued in pipeline Flows 3, 7, 9 and 11, and instructions from T3 can be issued in pipeline Flows 4, 8 and 10. This is despite the fact that all other contexts are suspended waiting for their cache misses to be resolved.

In this scenario, even if three of the active contexts have suffered a cache miss, the instruction pipeline utilization is still 50%. This is due to the fact that instructions from the single active context cannot be issued in back-to-back cycles due to the E-E bypass elimination context issue rule. However, the occurrence of this situation is considered rare, and trading off the penalty in this unlikely situation is well worth the overall increased throughput obtained by eliminating the E-E and M-E bypass paths.

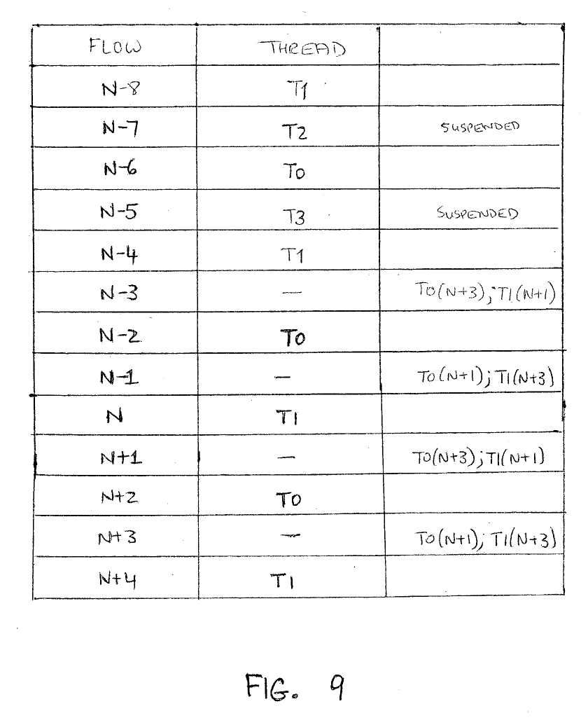

FIG. 9 is a flow diagram illustrating 50% utilization of the pipeline with two contexts issuing instructions according to the context issue rules. If only two contexts are issuing instructions, a logical state can occur where none of the active contexts can issue an instruction. This results in reduced utilization of the instruction pipeline.

In this situation, instructions were issued for four different active contexts, T0, T1, T2, and T3 in respective pipeline Flows N−8, N−7, N−6 and N−5. However, the instructions issued for T2 and T3 in pipeline Flows N−7 and N−5 are suspended due to cache misses in previously issued instructions leaving only contexts T0 and T2 active (in much the same manner as described for the example of FIG. 6). So, an instruction from T0 is issued in Flow N−6, but by Flow N−4, only T0 and T1 are active. T1 is selected because it is the oldest; that is, an instruction from T0 issued more recently (N−6) than the last instruction issued from T1 (N−8).

However, according to the context issue rules, both T0 and T1 are now prevented from issuing in Flow N−3. T0 is prevented from issuing in Flow N−3 because of the M-E bypass elimination context issue rule (N+3 rule). T1 is prevented from issuing because of the E-E bypass elimination context issue rule (N+1 rule). The context issue rules prevent T0 and T1 from issuing in all subsequent “odd” flows; that is, N−1, N+1, N+3. T0 or T1 issues in all subsequent “even” flows; that is, N, N+2 and N+4. Utilization of the pipeline is reduced to 50% because no context issues in “odd” Flows N−1, N+1, and N+3.

However, the scheduler 330 looks for this case and resolves the conflict by preventing one of the contexts from issuing, which later allows the other context to issue. A so-called “beat issue rule” can be devised that looks for the condition where no context issued in pipeline Flows N−3 and N−1 and another context issued in pipeline N−2. The beat issue rule can thus prevent the context which issued in pipeline Flow N−4 from issuing in pipeline Flow N. The beat issue rule can be as simple as a logic test for the following sequence: a context issued in Flow N−4, no context issued in pipeline Flows N−3 and N−1, and a different context issued in N−2. Upon detecting such a sequence, the context which issued in pipeline Flow N−4 is prevented from issuing in pipeline Flow N. The beat issue rule has been described for a pipeline in which contexts issue according to N+1 and N+3 context issue rules. Other beat issue rules can be devised if contexts are issued according to other context issue rules.

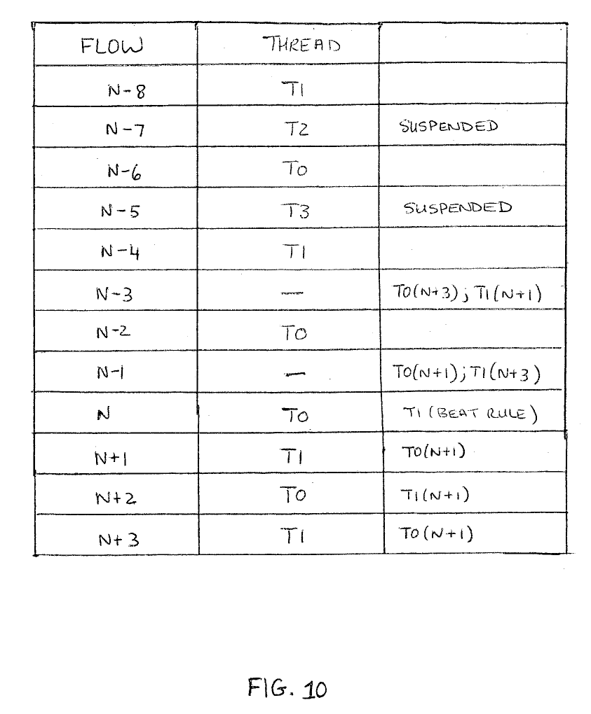

FIG. 10 illustrates increased pipeline utilization upon detecting the sequence of instructions shown in FIG. 9. At pipeline Flow N, T0 or T1 can issue. With only the context issue rules in play, the scheduler 330 will select T1 to issue because T0 issued in pipeline Flow N−2, and T1 last issued in an earlier pipeline Flow N−4. However, the addition of the beat issue rule allows T0 to issue in pipeline Flow N instead of T1. Postponing issuance of T1 to pipeline Flow N+1 in this instance permits the pipeline to then be filled by T0 and T1. The beat issue rule detects that T1 issued in pipeline Flow N−4, no context issued in pipeline Flow N−3 because T0 was prevented from issuing due to the N+3 rule, T1 was prevented from issuing due to the N+1 rule and T2 and T3 are stalled waiting for cache misses to be resolved. No context issued in pipeline Flow N−1 for reasons similar to Flow N−3, and finally a different context (T0) issued in N−2. Upon detecting the sequence, the context which issued in pipeline Flow N−4 (T1) is prevented from issuing in pipeline Flow N. Thus, T0 issues in pipeline Flow N. T1 issues in pipeline Flows N+1 and N+3 and T0 issues in pipeline Flow N+2 according to the context issue rules resulting in 100% utilization of the instruction pipeline. If more context issue rules than the N+1 and N+3 context issue rules are employed, more complex beat issue rules can be devised.

The invention has been described for a RISC processor having a multi-threaded pipeline, but it should be understood that the invention is not so limited. The invention applies to any processor having a multi-threaded pipeline.

One particular end application which benefits greatly from the use of context issue rules is a network packet processor. Such applications require processors which efficiently work on a large number of tasks in which there is very little data reuse—in other words, where cache misses occur frequently. For example, a processor may be processing packets for hundreds of thousands of Internet connections, such as HTTP sessions, in which each request requires transmission of data specific to the connection. In order to efficiently work on many tasks in parallel, the processor's throughput (overall packet processing) is more important than latency (the processing speed for a single packet). The context issue rules thus increase throughput, by eliminating the E-E and M-E bypass paths that might otherwise be included. Pipeline throughput is increased by (i) increasing pipeline stage clock speed; (ii) increasing pipeline utilization during normal execution; and (iii) reducing the number of stalls.

Furthermore, the context issue rules can permit a multi-threaded pipeline to continue execution, with 100% utilization, even in the event of a cache miss by one or more contexts.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for increasing processor throughput, the processor having a multi-threaded pipeline comprising the steps of:
concurrently processing a plurality of contexts; and
dynamically assigning the plurality of contexts to pipeline flows according to a context issue rule.

2. The method of claim 1 wherein the number of contexts is at least two.

3. The method of claim 2 wherein the number of contexts is 4.

4. The method of claim 1 wherein the context issue rule prevents a context which issues in a pipeline flow from issuing in a successive pipeline flow.

5. The method of claim 4 wherein the context issue rule prevents a context which issues in pipeline Flow N from issuing in pipeline Flow N+1.

6. The method of claim 5 wherein a result of an execution stage in the pipeline flow for the context is available at least one cycle before a successive pipeline flow for the context enters the execution stage.

7. The method of claim 1 where the context issue rule prevents a context which issues in pipeline Flow N from issuing in pipeline Flow N+P, where P depends upon a configuration of stages of the pipeline.

8. The method of claim 7 where P is dependent on a number of stages between at least two predetermined pipeline stages.

9. The method of claim 8 wherein the predetermined stages are an execution stage and a memory stage.

10. The method of claim 9 wherein P=2 plus the number of stages between the execution stage and a memory stage.

11. The method of claim 7 wherein P=3.

12. The method of claim 6 wherein data retrieved from a memory stage in a pipeline flow for the context is available prior to a successive pipeline flow for the context entering an execution stage.

13. The method of claim 1 wherein a result of a branch instruction is available for a successive instruction in a same context to select a next address without prediction.

14. The method of claim 13 wherein the result is available after a delay slot instruction.

15. The method of claim 1 wherein a jump destination resulting from a data dependent jump instruction is available for a successive instruction in the same context.

16. The method of claim 15 where the jump destination is available after a delay slot instruction.

17. The method of claim 1 wherein the multi-threaded pipeline is filled by two contexts issuing in alternate cycles.

18. The method of claim 1 wherein upon determining no context issued in pipeline Flows N+1 and N+3, and determining that a different context issued in pipeline Flow N+2, the context which issued in pipeline Flow N is prevented from issuing in pipeline Flow N+4.

19. The method of claim 1 wherein pipeline stalls due to delayed results are less frequent.

20. A processor comprising:
a multi-threaded pipeline which concurrently processes a plurality of contexts; and
a scheduler which dynamically assigns the plurality of contexts to pipeline Flows according to a context issue rule.

21. The processor of claim 20 wherein the number of contexts is at least two.

22. The processor of claim 21 wherein the number of contexts is 4.

23. The processor of claim 20 wherein the context issue rule prevents a context which issues in a pipeline Flow from issuing in a successive pipeline Flow.

24. The processor of claim 23 wherein the context issue rule prevents a context which issues in pipeline Flow N from issuing in pipeline Flow N+1.

25. The processor of claim 24 wherein a result of an execution stage in a pipeline Flow for a context is available at least one cycle before a successive pipeline Flow for the context enters the execution stage.

26. The processor of claim 20 where the context issue rule prevents a context which issues in pipeline Flow N from issuing in pipeline Flow N+P, where P depends upon a configuration of stages of the pipeline.

27. The processor of claim 26 where P is dependent on a number of stages between at least two predetermined pipeline stages.

28. The processor of claim 27 wherein the predetermined stages are an execution stage and a memory stage.

29. The processor of claim 28 wherein P=2 plus the number of stages between the execution stage and a memory stage.

30. The processor of claim 26 wherein P=3.

31. The processor of claim 27 wherein data retrieved from a memory stage in a pipeline Flow for the context is available prior to a successive pipeline Flow for the context entering an execution stage.

32. The processor of claim 20 wherein a result of a branch instruction is available for a successive instruction in a same context to select a next address without prediction.

33. The processor of claim 32 wherein the result is available after a delay slot instruction.

34. The processor of claim 20 wherein a jump destination resulting from a data dependent jump instruction is available for a successive instruction in the same context.

35. The processor of claim 34 wherein the jump destination is available after a delay slot instruction.

36. The processor of claim 20 wherein the multi-threaded pipeline is filled by two contexts issuing in alternate cycles.

37. The processor of claim 20 wherein upon determining no context issued in pipeline Flows N+1 and N+3, and a different context issued in pipeline Flow N+2, the context which issued in pipeline Flow N is prevented from issuing in pipeline Flow N+4.

38. The processor of claim 20 wherein pipeline stalls due to delayed results are less frequent.
